(19) United States
(12) Patent Application Publication
(10) Pub. No.: US 2012/0164287 A1
(43) Pub. Date: Jun. 28, 2012

(54) Pasta Product Having Reduced Sodium Anti-Boil-Over Composition With Enhanced Cheese Flavor Notes

(76) Inventors: Pamela Lynn Lundberg, Crystal Lake, IL (US); Taras Peter Drozd, Chicago, IL (US); James Donald Colby, Arlington Heights, IL (US); Vaidyam Deepti Rao, Naperville, IL (US)

(21) Appl. No.: 13/331,774

(22) Filed: Dec. 20, 2011

Related U.S. Application Data
(60) Provisional application No. 61/426,809, filed on Dec. 23, 2010.

(51) Int. Cl. A23L 1/162; A23L 1/01

(52) U.S. Cl. 426/243; 426/557

(57) ABSTRACT

A method and composition for reducing sodium in a pasta product having a cheese component and an anti-boil-over component without compromising the cheese flavor of the pasta product. The sodium chloride in the anti-boil-over composition is replaced with a sodium replacer including at least one of a modified potassium chloride or a bonded potassium chloride. Modified potassium chloride can include potassium chloride, rice flour, citric acid, L-lysine and rosemary extract. Bonded potassium chloride can include potassium chloride and natural flavors. The sodium replacer can include potassium chloride with at least either of the modified potassium chloride or the bonded potassium chloride. The addition of sodium replacers to the anti-boil-over component results in enhanced cheese flavors.

### CROSS REFERENCE TO RELATED PATENT APPLICATIONS

This application claims the benefit of U.S. Provisional Application No. 61/426,809 filed on Dec. 23, 2010, which is herein incorporated by reference.

### FIELD

The field relates to anti-boil-over compositions having a reduced sodium content. More specifically, the field relates to anti-boil-over compositions for use with microwaveable pasta products, the reduced sodium anti-boil-over composition providing an improved flavor profile in the final cooked product.

### BACKGROUND

Convenience foods typically require a minimum amount of consumer preparation and, thus, are in high demand to accommodate today's busy lifestyles. Microwave ovens are often used to heat, thaw, or cook the convenience foods. However, with regard to pasta dishes, microwave ovens generally are limited to thawing frozen pasta and/or heating pre-cooked, acidified, frozen, or chilled pasta dishes because of problems associated with pasta boil-over in the microwave oven during cooking.

In general, when noodles are cooked on the stove top, boil-over can easily be prevented or controlled by adjusting the heating power and/or monitoring the boiling conditions. A traditional solution to the problem of boil-over during stove top cooking of pasta is constant and/or frequent stirring along with control of heating conditions. However, when microwave ovens are used for such cooking, the heating power cannot be easily controlled by monitoring and/or manipulating cooking conditions. The nature of microwave cooking also does not make stirring or control of heating conditions viable solutions. Frequent stirring would also significantly reduce consumer convenience normally associated with microwave cooking (i.e., cooking with minimal consumer effort and/or intervention). Accordingly, cooking pasta using a microwave often results in boil-over and other associated problems.

Another method to prevent boil-over during stove top cooking of pasta is the use of an oversized container (i.e., allowing significant amount of space above the surface of the water) to allow for high boiling within the container. Typically, boil-over can be prevented by cooking pasta in a container more than three times the volume of the uncooked pasta/water mixture. However, packaging convenience foods configured for microwave ovens in oversized containers is typically not desired because the large containers can appear to the consumer to be only partially full (generally on the order of about a third full) after it is fully cooked. Moreover, if an oversized cooking container is included within the product package, the package will require a larger amount of shelf space in a grocery or retail store.

As a result, in most current microwave oven pasta products the pasta is cooked in a bowl supplied by the consumer which supplies enough space above the surface of the water to prevent boil-over. However, this creates added preparation time and inconvenience for the consumer. In addition, the consumer may choose a bowl too small and boil-over may still occur.

In some cases, there may also be a desire to provide a microwaveable pasta product that has a reduced sodium content. Sodium reduction, however, tends to decrease saltiness perception. A reduction in saltiness may also impact overall flavor profile, cheese flavor notes, sauce texture, and in some cases, potentially introduce bitter flavor notes depending on what other ingredients may be added to the product.

### SUMMARY

A method for preparing a pasta product comprising the steps of combining pasta, water, and an effective amount of an anti-boil-over composition in a container, the anti-boil-over composition including at least one surfactant, instant starch, sodium chloride, and sodium replacer including a modified potassium chloride having potassium chloride, rice flour, citric acid, L-lysine and rosemary extract is provided. The pasta, water, and anti-boil-over composition is heated in the container until the pasta is cooked to the desired degree of tenderness to form a heated mixture. The heated mixture is combined with a cheese component to form the pasta product.

In another approach, a method for preparing a pasta product comprising the steps of combining pasta, water, and an effective amount of an anti-boil-over composition in a container, the anti-boil-over composition including at least one surfactant, instant starch, sodium chloride, and sodium replacer including bonded potassium chloride having potassium chloride and natural flavors is provided. The pasta, water, and anti-boil-over composition is heated in the container until the pasta is cooked to the desired degree of tenderness to form a heated mixture. The heated mixture is combined with a cheese component to form the pasta product.

By another approach, a method for preparing a pasta product comprising the steps of combining pasta, water, and an effective amount of an anti-boil-over composition in a container, the anti-boil-over composition including at least one surfactant, instant starch, sodium chloride, and sodium replacer, the sodium replacer including a blend of potassium chloride and at least one of a modified potassium chloride or a bonded potassium chloride, wherein the ratio of sodium chloride, potassium chloride, and at least one of the modified potassium chloride or the bonded potassium chloride is between about 3:2:11 to about 5:5:15 by wt % is provided. The pasta, water, and anti-boil-over composition is heated in the container until the pasta is cooked to the desired degree of tenderness to form a heated mixture. The heated mixture is combined with a cheese component to form the pasta product.

By yet another approach, an anti-boil-over composition for cooking pasta, the composition comprising at least one surfactant; instant starch; sodium chloride; and sodium replacer including at least one of a modified potassium chloride or a bonded potassium chloride is provided.

The methods and the anti-boil-over composition provided are effective to form a reduced sodium pasta and cheese product with enhanced cheese flavors.

### DETAILED DESCRIPTION

Pasta products and methods of preparing pasta products configured for easy preparation, such as preparation using a microwave oven, are provided. The pasta products herein include a pasta component, a cheese component, and an anti-foam or anti-boil-over component in an assembly effective to allow the pasta to be prepared in a microwave oven. The pasta product is prepared by combining pasta, water, and the anti-boil-over component in a container, and heating the pasta, water and anti-boil-over component in the container until the pasta is cooked to the desired degree of tenderness. The cheese component can be added prior to, or after the heating of the pasta, water, and the anti-boil-over component. As used herein, anti-foam and anti-boil-over are used interchangeably.

Typically, salt or sodium chloride is included in both the anti-foam and cheese components. Due to the increasing health consciousness of consumers, it is desirable to reduce the amount of sodium in the pasta product. Some of the challenges involved in reducing the sodium in a product are that, in addition to decreasing saltiness perception, reducing sodium can also impact a consumer's perception of overall flavor, and texture. The reduction of sodium may cause the consumer to perceive a reduced cheese flavor impact.

Sodium replacers have been used to replace the amount of sodium in food, while attempting to maintain the perceived saltiness of the food. However, when sodium replacers are used in a pasta product with a cheese component, bitter notes are often introduced into the product.

The pasta products provided herein have a reduced sodium level compared to conventional microwavable pasta products, without compromising the cheese flavor imparted by the cheese component. Surprisingly, the pasta products disclosed herein have enhanced cheese flavor notes even when the pasta products have a reduction of up to about 30 percent sodium as compared to non-salt reduced, traditional microwaveable pasta products with a cheese component. The present inventors have discovered that the reduction of sodium level in the composition of the anti-boil-over component combined with the addition of certain salt replacers in the anti-boil-over composition, rather than the addition of the salt replacers in the cheese component, leads to the unexpected results of (1) a salt reduction in the pasta product without compromising the cheese flavor, and (2) an enhanced cheese flavor in the pasta product. Surprisingly, it was discovered that if the sodium replacers were added to the cheese component, the enhanced cheese flavor was not experienced.

In one approach, a reduced sodium pasta product is prepared by combining pasta, water, and an effective amount of an anti-boil-over composition in a container. In this approach, the anti-boil-over composition includes at least one surfactant, instant starch, sodium chloride, and sodium replacers. The pasta is prepared by heating the pasta, water, and anti-boil-over composition in the container until the pasta is cooked to the desired degree of tenderness.

In one approach, the sodium replacer may be a modified potassium chloride. Modified potassium chloride can include potassium chloride with effective amounts of secondary components such as starches, acids, and/or flavor extracts in amounts and combinations effective to result in enhanced cheese flavor. The modified potassium chloride may include effective amounts of a combination of rice flour, citric acid, amino acids, and/or flavor extracts. Amino acids such as L-lysine, and flavor extracts such as rosemary can be used. In one approach, effective amounts of rice flour, citric acid, amino acid, and flavor extracts may include between about 76% to about 86% potassium chloride, between about 12% to about 22% rice flour, between about 0% to about 6.5% citric acid, between about 0% to about 5% L-Lysine, and between about 0% to about 5% rosemary extract by weight of the modified potassium chloride. In yet another approach, effective amounts of rice flour, citric acid, amino acid, and flavor extracts may include about 81% potassium chloride, about 17% rice flour, about 1.5% citric acid, about 0.2% L-lysine, and about 0.1% rosemary extract by weight of the modified potassium chloride. The presence of the secondary components in the modified potassium chloride was expected to cause a negative impact to the flavor, but instead the use of the modified potassium chloride having the secondary components provided a decrease in bitter flavor as compared to the use of potassium chloride alone as a salt replacer, and provides the surprising result of flavor enhancement. It was not expected that the addition of rice flour, citric acid, amino acids, and/or flavors (such as rosemary) would have any effect on cheese flavors. More surprisingly, the enhanced cheese flavor only results from the addition of the modified sodium replacers to the anti-foam component. Addition of the same modified potassium chloride directly in the cheese component did not result in enhanced cheese flavors. The pasta products herein may include an increase in levels of starches and acids due to the inclusion of these ingredients from the sodium replacer.

In another approach, the sodium replacer may be a bonded potassium chloride. Bonded potassium chloride can include potassium chloride and natural flavorings. In one approach, bonded potassium chloride may include between about 93.5% to about 100% potassium chloride, and between about 0% to about 6.5% natural flavors by weight of the bonded potassium chloride. By another approach, bonded potassium chloride may include about 98.5% potassium chloride and about 1.5% natural flavors by weight of the bonded potassium chloride. The use of bonded potassium chloride provides a decrease in bitter flavor as compared to the use of potassium chloride alone as a salt replacer, and provides the surprising result of flavor enhancement. Such enhanced forms of potassium chloride are typically expected to suppress bitter flavors and other flavors, and would not have been expected to enhance cheese flavor. More surprisingly, an enhanced cheese flavor only results from the addition of sodium replacers to the anti-foam component.

By yet another approach, the sodium replacer may include a blend of potassium chloride and at least one of a modified potassium chloride or a bonded potassium chloride. The ratio of sodium chloride, potassium chloride, and at least one of a modified potassium chloride or bonded potassium chloride is between about 3:2:11 to about 5:5:15 by weight percent.

In other approaches, the sodium chloride, potassium chloride, and modified or bonded potassium chloride are in a ratio of about 4:3.5:13. That is, the potassium chloride in the salt replacers is at least about 4 times that of the sodium chloride and the modified or bonded sodium replacer is at least about 3 times that of the sodium chloride. In another embodiment, the reduced sodium anti-boil-over composition includes surfactant, instant starch, sodium chloride, and straight potassium chloride; wherein the sodium chloride and potassium chloride are in a ratio of about 3:14 to about 5:20. In one approach, the sodium chloride and straight potassium chloride are in a ratio of about 4:16.5.

In some embodiments, anti-foam compositions that include at least about 4 times and up to about 6 times more sodium replacer than sodium chloride may be effective to form a final pasta product comprising a cheese component with an enhanced cheese flavor. In this approach, the sodium replacer may be straight potassium chloride, modified potassium chloride, bonded potassium chloride, or a combination thereof.

In one approach, the anti-boil-over composition may include about 5 to about 30 percent surfactant, about 50 to about 70 percent instant starch, and at least about 14 percent salt (including both sodium chloride and sodium replacer) by weight of the anti-boil-over component. In another approach, the anti-boil-over composition includes about 10 to about 20 percent surfactant, about 50 to about 60 percent instant starch, and about 20 to about 30 percent salt (including both sodium chloride and the sodium replacer). In yet other approaches, the anti-boil-over composition includes about 12 to about 17 percent surfactant, about 55 to about 60 percent instant starch, and about 23 to about 28 percent salt (including both sodium chloride and sodium replacer).

In another embodiment, the anti-boil-over composition includes about 5 to about 20 percent surfactant, about 50 to about 70 percent instant starch, at least about 2 percent sodium chloride, and at least about 12 percent sodium replacer. In other approaches, the reduced sodium, anti-boil-over composition includes about 12 to about 17 percent surfactant, about 55 to about 60 percent instant starch, and about 3 to about 5 percent sodium chloride, and about 19 to about 34 percent sodium replacer.

Suitable surfactants for use in the anti-boil-over composition include monoglycerides, diglycerides, derivatives thereof (e.g., acetylated monoglycerides, succinylated monoglycerides, citrated monoglycerides, and the like) as well as mixtures thereof. Acetylated monoglycerides are generally suitable for the compositions herein.

Suitable instant starches for use in the anti-boil-over composition include instant and/or pregelatinized starches such as corn or tapioca starches and the like as well as mixtures thereof. By one approach, suitable instant starches include pregelatinzed corn starch, instant tapioca starch, and mixtures thereof. Without wishing to be bound by any particular theory, it is believed that the instant starch increases the viscosity of the aqueous medium at ambient temperatures and helps to maintain that viscosity increase at boiling temperatures.

Suitable salts for use in the anti-boil-over composition include sodium chloride, potassium chloride, magnesium chloride, the sodium replacers discussed above, and the like as well as mixtures thereof. Sodium chloride is one suitable salt for the applications and compositions herein. Again without wishing to be bound by any particular theory, it is possible that the salt provides a salting out effect, modifies the surface potential of the pasta, modifies the viscosity of the aqueous medium, and/or increases the boiling point of the aqueous medium.

Suitable sodium replacers include those discussed above such as potassium chloride, modified potassium chloride, bonded potassium chloride and mixtures thereof. Without wishing to be bound by any particular theory, the sodium replacers may also provide a salting out effect, cause modifications to the surface potential of the pasta, cause modifications to the viscosity of the aqueous medium, and/or increase the boiling point of the aqueous medium.

The sodium chloride in a pasta product having a cheese component, a pasta component, and an anti-boil component can be reduced by substituting at least a portion of the sodium chloride in the composition of the anti-boil-over component with a sodium replacer. The sodium replacer can include at least one of a modified potassium chloride or a bonded potassium chloride, and in some aspects further includes potassium chloride. In one approach, the substitution of sodium chloride in the anti-boil-over component can be up to an amount effective to reduce sodium chloride in the pasta product by about 30%. Surprisingly, the substitution of sodium chloride with the sodium replacers described herein in an amount effective to decrease the sodium chloride in the pasta product by up to 30% did not result in a compromised cheese flavor, but rather led to enhancing the cheese flavor of the pasta product. When the sodium replacers were added to the cheese component, the resulting product had bitter notes. The cheese component of the pasta product may comprise cheese, cheese powder, cheese sauce, or a combination thereof.

To prepare the pasta product, the mixture of the pasta component, water, and the anti-boil over component is heated in a limited volume container until the pasta achieves the desired degree of tenderness and forms the cooked pasta. For purposes of this disclosure, a limited volume container generally has about 1 to about 2 inches of head space (as determined under ambient or non-boiling conditions) above the pasta/water level. Without the described anti-boil-over composition, boil-over may be significant when cooking dried pasta. Of course, the described anti-boil-over composition may be used to cook dried pasta in other containers if desired. The anti-boil-over compositions are effective and configured to significantly reduce boil-over in the limited volume container during heating relative to a similar pasta and water mixture, but without the anti-boil-over composition, heated in a similar manner. The heating of the mixture can be carried out using microwave heating techniques or conventional heating techniques (e.g., stove top cooking and the like).

Turning now to an exemplary discussion on how the pasta product is assembled or packaged, in one approach, the various ingredients may be added to the pasta before cooking. For example, the anti-boil-over composition could be packaged in a separate container(s) and then added to the water/pasta mixture at the beginning of the cooking process. It would be more convenient for the anti-boil-over composition to be packaged with the dried pasta; this would, of course, also prevent situations wherein the consumer forgets to add the anti-boil-over composition. However, as discussed in more detail below, it has been found that cooking pasta in water containing the anti-boil-over composition can, under some conditions (especially when the pasta and the anti-boil-over composition are in direct contact during shipping and storage in the package), result in non-uniform cooking of the pasta, as evidenced by the presence of hard or undercooked pasta. To avoid this problem, the surfactants can be, and preferably are, plated or deposited onto the instant starch (e.g., powder coating, fluidized bed coating) to effectively obtain agglomerated particles. The resulting composite is then combined with the salt to form the anti-boil-over composition. Alternatively, the salt could be combined with the other ingredients prior to the plating step. In still another alternative, the salt could be added by the consumer to the pasta/water/surfactant/instant starch composition just prior to cooking. Again not wishing to be limited by theory, it is thought that the plating or depositing step increases the surface area as well as particle size of the material to allow quicker solubility in water and/or to limit entry of the surfactant/instant starch particles into cracks or fissure in the dried pasta during the packaging, transportation, and storage periods.

An effective amount of the anti-boil-over composition is added to the pasta in a limited volume container. The effective amount of anti-boil-over to pasta may be about 2 to about 5 g of anti-boil-over composition to about 30 to about 50 g of pasta, and in some cases about 3 to about 4 g of anti-boil-over composition to about 35 to about 45 g of pasta. Generally, the ratio of anti-boil-over composition to pasta may be about 1:10 to about 1:15. The effective amount of anti-boil-over, pasta, and water is about 2 to about 5 g of anti-boil-over composition, about 30 to about 50 g of pasta, and about 125 to about 175 g water, and in some cases about 3 to about 4 g of anti-boil-over composition, about 35 to about 45 g of pasta, and about 145 to about 155 g water. Thus, the ratio of anti-boil-over composition to pasta to water is about 1:10:35 to about 1:15:55.

The presently described anti-boil-over composition is effective in reducing boil-over in the limited volume container in a microwave oven. However, it has been found that cooking pasta in water containing the anti-boil-over composition can, under some conditions (especially when the pasta and the anti-boil-over composition are in direct contact during shipping and storage in the package), result in non-uniform cooking of the pasta, as evidenced by the presence of hard or undercooked pasta. Without wishing to be bound by any particular theory, it is thought that the improper hydration is a result of the anti-boil-over composition powder being trapped in the pasta (especially in pasta such as elbow spaghetti and elbow macaroni and the like). To address this issue, methods were developed to enable uniform hydration of pasta in which the exposure of the dried pasta to the anti-boil-over composition is limited. In such cases, non-powdered forms of the anti-boil-over composition (and/or sauce preblend) can be used. Examples of such non-powdered forms include tablets, agglomerates, and the like which remain intact or essentially intact during the initial portion of the cooking. During cooking, the non-powdered form breaks up, thereby releasing the anti-boil-over composition into the water. Thus, boil-over is significantly reduced or eliminated and uniform hydration of pasta during cooking is achieved. Alternatively, the anti-boil-over composition (powdered or non-powdered forms) could be packaged separately from the dried pasta and only added just before cooking or just after cooking begins. Generally, however, the non-powdered forms of the anti-boil-over composition are preferred.

In some instances, it has also been found that packaging a dry sauce preblend in a non-powdered form (with or without the anti-boil-over composition) allows the pasta and the dry sauce preblend to be packaged together and still allows for uniform cooking of the pasta even in cases where the pasta is not stirred prior to, and/or during, cooking.

A pasta dinner kit comprising dried pasta and a dry sauce preblend, wherein the dried pasta and the sauce preblend are packaged in a single package and wherein the dry sauce preblend is in a non-powdered form, whereby the dried pasta and the dry sauce preblend can be cooked together to form a pasta dinner in which the pasta is uniformly cooked is provided. In one form, the dry sauce preblend forms a cheese sauce when the dried pasta and the dry sauce preblend are cooked together. In another form, the dry sauce preblend also contains an effective amount of the anti-boil-over composition in a non-powdered form. By including the dry sauce preblend, with or without the non-powdered anti-boil-over composition, in a non-powdered form, a uniformly cooked pasta (i.e., without undercooked portions) can be prepared even if the dried pasta and dry sauce preblend in the single package are stored together during long periods of time. Including the dry sauce preblend (and the anti-boil-over composition if present) in a non-powdered form appears to prevent the absorption or inclusion of powder within, or on the surface of, the pasta during storage, thereby allowing for more uniform cooking, even in cases where the pasta is not stirred before or during cooking.

By one approach, to produce a uniformly cooked pasta dish a dry sauce preblend in a non-powdered form is formed, and packaged with the dried pasta in a single package. The dried pasta and the dry sauce preblend can be cooked together to form the cooked pasta dish in which the pasta is uniformly cooked.

The following examples are illustrative, and not limiting thereof in either scope or spirit. Those skilled in the art will readily understand that variations of the components, methods, steps, and devices described in these examples can be used. Unless noted otherwise, all percentages are by weight.

### EXAMPLES

### Example 1

This example illustrates the use of sodium replacers added via the anti-boil-over component as compared to sodium replacers added to the cheese component. This example also compares modified potassium chloride, bonded potassium chloride, and potassium chloride as salt replacers when the sodium in the anti-boil-over composition is reduced by about 30%. The example compares (1) the salt replacers added to the anti-boil-over component to (2) the salt replacers added to the cheese component.

Table 1 below lists the composition of the anti-boil-over component when salt is reduced by about 30% in the anti-boil-over composition and replaced by salt replacers in the anti-boil-over component.

TABLE 1
Anti-Boil-Over Component Composition (wt %)
(30% Sodium Reduction/With Salt Replacers)

| | |
|---|---|
| Corn Starch | 52.7 |
| Maltodextrin | 20 |
| Monoglyceride | 4.7 |
| Sodium Chloride | 4.2 |
| Sodium Replacer | 13.3 |
| Triglyceride | 1.6 |
| Potassium Chloride | 3.5 |
| Total: | 100 |

Table 2 below lists the composition of the anti-boil over component and the composition of the cheese component when salt is reduced by about 30% in the anti-boil composition, and salt replacers are added with the cheese component to compensate for the reduction in sodium chloride in the anti-boil-over component.

TABLE 2

| Anti-Boil-Over Component | | | |
|---|---|---|---|
| Composition (wt %) | | | |
| (30% Sodium Reduction/No Salt | | Cheese Component (grams) | |
| Replacers) | | (With Salt Replacers) | |
| Corn Starch | 60 | Cheese Base | 14.4 g |
| Maltodextrin | 21 | Sodium Replacer | 0.5 g |
| Monoglyceride | 4.7 | | |
| Sodium Chloride | 4.4 | | |
| Triglyceride | 1.6 | | |
| Potassium Chloride | 8.2 | | |
| Total: | 100 | Total: | 14.9 g |

The pasta samples of Table 1 and Table 2 were prepared by combining about 40 g of dry pasta, about 3.8 grams of anti-boil-over composition, and about 149 mL of water in a microwave safe container. The combination was heated in a conventional microwave oven on high for about 3 minutes and 30 seconds. After heating, about 14.5 g of cheese powder (and about 0.5 g sodium replacer for Table 2 preparations) was mixed into the heated combination.

Three sets of comparative samples were prepared to test the effect of sodium replacers in microwaveable macaroni and cheese. In the first set of comparative samples, a first sample was prepared using the 30 percent reduced sodium anti-boil-over composition containing modified potassium chloride as the sodium replacer in the amount indicated in Table 1 and compared to a second sample using a 30 percent reduced sodium anti-boil-over composition without a sodium replacer from Table 2, but where the amount of sodium replacer included in the first sample was instead included with the cheese powder when mixed with the heated combination as described above. The modified potassium chloride included potassium chloride, rice flour, citric acid, L-lysine, and rosemary extract.

In the second set of comparative samples, a third sample was prepared using the 30 percent reduced sodium anti-boil-over composition containing bonded potassium chloride as the sodium replacer in the amount indicated Table 1 and compared to a fourth sample using a 30 percent reduced sodium anti-boil-over composition without a sodium replacer of Table 2, but where the amount of sodium replacer included in the third sample was instead included with the cheese powder when mixed with the heated combination as described above. The bonded potassium chloride included potassium chloride and natural flavors.

In the third set of comparative samples, a fifth sample was prepared using the 30 percent reduced sodium anti-boil-over composition containing straight potassium chloride as the sodium replacer in the amount indicated Table 1 and compared to a sixth sample using a 30 percent reduced sodium anti-boil-over composition without a sodium replacer in Table 2, but where the amount of sodium replacer included in the fifth sample was instead included with the cheese powder when mixed with the heated combination as described above.

The pasta samples of Table 1 and Table 2 formed with the modified potassium chloride, bonded potassium chloride, and potassium chloride as salt replacers were presented to a taste panel. The results of the taste panel are shown below:

| | Comparative Test Results Between Table 1 and |
|---|---|
| Salt Replacer Type | Table 2 Preparations |
| Modified KCL | Formulation using Table 1 had cheesier flavor than |
| | Formulation using Table 2 |
| Bonded KCL | Formulation using Table 1 had cheesier flavor than |
| | Formulation using Table 2 |
| KCL | Formulation using Table 1 had cheesier flavor than |
| | Formulation using Table 2 |

In each of the sets of comparative samples, the samples where the sodium replacer was provided in the reduced sodium anti-boil-over composition was evaluated by the taste panel as having a cheesier taste and a saltier taste than corresponding samples where the sodium replacer was provided with the cheese powder.

### Example 2

Example 2 varies the cooking order of the components. The anti-boil-over composition/cheese composition were prepared in accordance with either Table 1 or Table 2, using modified potassium chloride as the sodium replacer. The cooked pasta product was prepared by varying the order in which the anti-boil-over composition or the cheese component was added to the pasta and water mix. Six samples were prepared as follows:

The first sample in this Example is equivalent to the first sample prepared above, where about 3.8 g of a 30% reduced sodium anti-boil-over composition containing modified potassium chloride as the sodium replacer in the amount of Table 1 above was combined with about 40 g of dry pasta and about 149 mL of water, cooked, and then mixed with about 14.5 g of the standard cheese powder.

The second sample in this Example is equivalent to the second sample described in the prior example where about 3.8 g of a 30% reduced sodium anti-boil-over composition without a sodium replacer of Table 2 was combined with about 40 g of dry pasta and about 149 mL of water, cooked, and then mixed with about 14.5 g of the standard cheese powder and an equivalent amount of sodium replacer (0.5 g) that was contained in the first sample.

In the third sample of this set about 40 g of dry pasted, about 14.5 g of cheese powder, and about 149 mL of water were combined, cooked, and then mixed with about 3.8 g of 30% reduced sodium anti-boil-over composition containing modified potassium chloride as the sodium replacer in the amount of Table 1.

In the fourth sample of this set, about 40 g of pasta, about 14.5 g of cheese powder, 0.5 g of modified potassium chloride, and about 149 mL of water were combined, cooked, and then mixed with about 3.8 g of the 30% reduced sodium anti-boil-over composition without a sodium replacer of Table 1.

In the fifth sample of this set, about 40 g of pasta and about 149 mL of water were combined, cooked, and then mixed with about 3.8 g of the 30% reduced sodium anti-boil-over composition without a sodium replacer and about 14.5 g of cheese powder with about 0.5 g of modified potassium chloride.

In the sixth sample, about 40 g of pasta, about 14.5 g of cheese powder, about 0.5 g of modified potassium chloride, about 3.8 g of the 30% reduced sodium anti-boil-over composition without a sodium replacer and about 149 mL of water were combined and cooked.

The third, fourth, fifth, and sixth samples could not be evaluated by the taste testing panel due to undesirable textural changes that occurred during the cooking of the pasta. Between the first two samples, the sodium replacer added in the anti-boil-over composition was determined to have a cheesier taste than the second sample when consumed hot, but as the samples cooled down the second sample was found have a cheesier taste than the first sample.

It will be understood that various changes in the details, materials, and arrangements of the process, formulations, and ingredients thereof, which have been herein described and illustrated in order to explain the nature of the method and resulting pasta product, may be made by those skilled in the art within the principle and scope of the embodied method as expressed in the appended claims.

What is claimed is:

1. A method for preparing a pasta product comprising the steps of:
combining pasta, water, and an effective amount of an anti-boil-over composition in a container, the anti-boil-over composition including at least one surfactant, instant starch, sodium chloride, and sodium replacer including a modified potassium chloride having potassium chloride, rice flour, citric acid, L-lysine and rosemary extract;
heating the pasta, water, and anti-boil-over composition in the container until the pasta is cooked to the desired degree of tenderness to form a heated mixture; and
combining the heated mixture with a cheese component to form the pasta product.

2. The method of claim 1 wherein the modified potassium chloride includes between about 76 wt % to about 86 wt % potassium chloride, between about 12 wt % to about 22 wt % rice flour, between about 0 wt % to about 6.5 wt % citric acid, between about 0% wt % to about 5 wt % L-lysine, and between about 0 wt % to about 5% rosemary extract.

3. The method of claim 1 wherein the step of heating is performed using a microwave.

4. The method of claim 1 wherein the surfactant is present in an amount of between about 5 wt % to about 30 wt %, the instant starch is present in an amount of between about 50 wt % to about 70 wt %, and the amount of sodium chloride and sodium replacer combined is at least about 14 wt %.

5. A method for preparing a pasta product comprising the steps of:
combining pasta, water, and an effective amount of an anti-boil-over composition in a container, the anti-boil-over composition including at least one surfactant, instant starch, sodium chloride, and sodium replacer including bonded potassium chloride having potassium chloride and natural flavors;
heating the pasta, water, and anti-boil-over composition in the container until the pasta is cooked to the desired degree of tenderness to form a heated mixture; and
combining the heated mixture with a cheese component to form the pasta product.

6. The method of claim 5 wherein the bonded potassium chloride includes between about 93.5 wt % to 100 wt % potassium chloride, and about 0 wt % to about 6.5 wt % natural flavors.

7. A method for preparing a pasta product comprising the steps of:
combining pasta, water, and an effective amount of an anti-boil-over composition in a container, the anti-boil-over composition including at least one surfactant, instant starch, sodium chloride, and sodium replacer, the sodium replacer including a blend of potassium chloride and at least one of a modified potassium chloride or a bonded potassium chloride, wherein the ratio of sodium chloride, potassium chloride, and at least one of the modified potassium chloride or the bonded potassium chloride is between about 3:2:11 to about 5:5:15 by wt %; heating the pasta, water, and anti-boil-over composition in the container until the pasta is cooked to the desired degree of tenderness to form a heated mixture; and
combining the heated mixture with a cheese component to form the pasta product.

8. The method of claim 7 wherein the ratio of sodium chloride, potassium chloride and at least one of the modified potassium chloride or the bonded potassium chloride is about 4:3.5:13 by wt %.

9. An anti-boil-over composition for cooking pasta, said composition comprising:
at least one surfactant;
instant starch;
sodium chloride; and
sodium replacer including at least one of a modified potassium chloride or a bonded potassium chloride.

10. The anti-boil-over composition of claim 9 wherein the modified potassium chloride includes potassium chloride, rice flour, citric acid, L-lysine, and rosemary extract.

11. The anti-boil-over composition of claim 10 wherein the modified potassium chloride includes between about 76 wt % to about 86 wt % potassium chloride, between about 12 wt % to about 22 wt % rice flour, between about 0 wt % to about 6.5 wt % citric acid, between about 0% wt % to about 5 wt % L-lysine, and between about 0 wt % to about 5% rosemary extract.

12. The anti-boil-over composition of claim 9 wherein the bonded potassium chloride includes potassium chloride and natural flavors.

13. The anti-boil-over composition of claim 12 wherein the bonded potassium chloride includes between about 93.5 wt % to 100 wt % potassium chloride, and about 0 wt % to about 6.5 wt % natural flavors.

14. The anti-boil-over composition of claim 9 wherein the sodium replacer further includes potassium chloride.

15. The anti-boil-over composition of claim 14 wherein the ratio of sodium chloride, potassium chloride, and at least one of a modified potassium chloride and bonded potassium chloride is between about 3:2:11 to about 5:5:15 by wt %.

16. The anti-boil-over composition of claim 9 wherein the surfactant is present in an amount of between about 5 wt % to about 30 wt %, the instant starch is present in an amount of between about 50 wt % to about 70 wt %, and the amount of sodium chloride and sodium replacer combined is at least about 14 wt %.
